(19) United States
(12) Patent Application Publication
(10) Pub. No.: US 2026/0098438 A1
(43) Pub. Date: Apr. 9, 2026

(54) REFRIGERATOR

(71) Applicants: HEFEI MIDEA REFRIGERATOR CO., LTD., HEFEI (CN); HEFEI HUALING CO., LTD., HEFEI (CN); MIDEA GROUP CO., LTD., FOSHAN (CN)

(72) Inventors: Bing SHI, HEFEI (CN); Bo PENG, HEFEI (CN); Shenghao QI, HEFEI (CN); Ronghai CHEN, HEFEI (CN); Zhuohua JIANG, HEFEI (CN); Xiuliang FU, HEFEI (CN); Yafei ZHU, HEFEI (CN); Yerui FENG, HEFEI (CN); Jinguo YUAN, HEFEI (CN); Chuandong WANG, HEFEI (CN)

(21) Appl. No.: 19/112,269

(22) PCT Filed: Jun. 28, 2023
(86) PCT No.: PCT/CN2023/103237

§ 371 Date: Mar. 17, 2025

(30) Foreign Application Priority Data
Sep. 20, 2022 (CN) 202211145486.9

(51) Int. Cl. E05F 15/63; F25D 23/02

(52) U.S. Cl. CPC E05F 15/63; F25D 23/028; E05Y 2201/71; E05Y 2900/31

(57) ABSTRACT

The disclosure discloses a refrigerator, including: a main body formed with an accommodation space that has an opening; a door body rotatably disposed on the main body via a rotating shaft to enclose or open the opening, the door opening and closing device including a front connecting rod; and a sliding assembly which includes a connecting member and a sliding member. The connecting member is fixed to one of the front connecting rod and the door body, the sliding member is disposed on another of the front connecting rod and the door body, and the sliding member is slidably connected to the connecting member, and thus the front connecting rod can move along an axial direction of the rotating shaft relative to the door body.

### CROSS-REFERENCES TO RELATED APPLICATIONS

The present disclosure is a national phase application of International Application No. PCT/CN2023/103237, filed on Jun. 28, 2023, which claims priority to Chinese patent application No. 202211145486.9, filed on Sep. 20, 2022, the entire contents of which are incorporated herein by reference.

### FIELD

The disclosure belongs to a field of electrical apparatus, and in particular relates to a refrigerator.

### BACKGROUND

With the improvement of living standards, electrical apparatuses such as refrigerators, dishwashers and disinfection cabinets have become widely used in lives of people. In particular, in order to maintain a sealing performance of the refrigerator, an adsorption structure is usually disposed between a main body and a door body thereof or negative pressure is maintained within the main body, to stably fix the door body to the main body. Although a related performance of the refrigerator is improved in this way, a difficulty of opening the door body is also increased to a certain extent. Since a larger force is usually required to open the door body of the refrigerator, it is inconvenient to use. In order to overcome the above problems, a door opening and closing device is used in the related art to open or close the door body. During the door body is opened or closed by the door opening and closing device, the door body is prone to be displaced up and down, resulting in a damage to the door opening and closing device.

### SUMMARY

The disclosure intends to at least to a certain extent solve a problem that a displacement of a door body affects a door opening and closing device. To this end, the disclosure provides a refrigerator.

According to some embodiments of the disclosure, a refrigerator is provided, which includes: a main body formed with an accommodation space which has an opening; a door body rotatably disposed on the main body via a rotating shaft to enclose or open the opening; a door opening and closing device disposed on the main body and connected to the door body, wherein when the door opening and closing device is activated, the door opening and closing device drives the door body to rotate relative to the main body to open or close the door body, the door opening and closing device comprising a front connecting rod; and a sliding assembly comprising a connecting member and a sliding member, wherein the connecting member is fixed to one of the front connecting rod and the door body, the sliding member being disposed on another of the front connecting rod and the door body, the sliding member being movably connected to the connecting member, and thus the front connecting rod is able to move along an axial direction of the rotating shaft relative to the door body.

### BRIEF DESCRIPTION OF THE DRAWINGS

In order to more clearly illustrate the embodiments of the disclosure, the accompanying drawings required for describing the embodiments are briefly introduced below. Obviously, the accompanying drawings in the following description only illustrate some embodiments of the disclosure, and other accompanying drawings can also be obtained based on these accompanying drawings.

FIG. 1 shows a schematic structural diagram of a refrigerator with an opened door body according to some embodiments of the disclosure;

FIG. 2 shows a schematic structural diagram of the refrigerator with a closed door body according to some embodiments of the disclosure;

FIG. 3 is a schematic structural diagram showing a connection way between a front connecting rod and a door body of the refrigerator according to some embodiments of the disclosure;

FIG. 4 shows an exploded view of the front connecting rod and the door body of the refrigerator of FIG. 3;

FIG. 5 is a schematic structural diagram showing a connection way between a front connecting rod and a door body of the refrigerator according to some embodiments of the disclosure;

FIG. 6 shows an exploded view of the front connecting rod and the door body of the refrigerator of FIG. 5;

FIG. 7 is a schematic structural diagram showing a connection way between a front connecting rod and a door body of the refrigerator according to some embodiments of the disclosure;

FIG. 8 shows an exploded view of the front connecting rod and the door body of the refrigerator of FIG. 7;

FIG. 9 is a schematic structural diagram showing a connection way between a front connecting rod and a door body of the refrigerator according to some embodiments of the disclosure; and

FIG. 10 shows an exploded view of the front connecting rod and the door body of the refrigerator of FIG. 9.

In the accompanying drawings, corresponding relationships between reference signs and component names are as follows:
10, refrigerator; 11, door opening and closing device; 12, main body; 13, door body; 14, fixing hole; 14b, fixing section; 14c, connecting section; 14d, fixing surface; 15, installation groove; 16, rotating shaft;
100, driving mechanism;
300, transmission mechanism;
400, door rotation mechanism; 410, front connecting rod; 412, limiting hole; 420, rear connecting rod; and
500, sliding assembly; 510, sliding member; 511, stop surface; 512, stop section; 513, installation section; 514, installation hole; 515, fixing slot; 520, connecting member; 521, connecting shaft; 523, end cover; 530, fixing member; 531, fixing portion; 532, connecting portion; 533, connecting hole; 534, first limiting portion; 535, second limiting portion; 537, transition portion; 538, installation portion.

### DETAILED DESCRIPTION OF THE DISCLOSURE

The embodiments of the disclosure will be clearly and completely described below with reference to the accompanying drawings in the embodiments of the disclosure. The described embodiments are only some embodiments, rather than all embodiments of the disclosure.

It should be noted that all directional indications in the embodiments of the disclosure are only configured to explain the relative position relationship, movement status and so on among the components in a specific posture. If the specific posture changes, the directional indication will also change accordingly.

In the disclosure, unless otherwise clearly stipulated and limited, the terms “connected”, “fixed” and so on should be understood in a broad sense. For example, “fixed” can be a fixed connection, a detachable connection, or an integral connection; it can be a mechanical connection or an electrical connection; it can be a direct connection or an indirect connection through an intermediate medium; it can be an internal connection of two elements or an interaction relationship between two elements, unless otherwise clearly limited. The specific meanings of the above terms in the embodiments of the disclosure can be understood according to specific circumstances.

In addition, descriptions such as “first”, “second” and so on in the disclosure are only used for descriptive purposes and cannot be understood as indicating or implying relative importance thereof or implicitly indicating the number of the indicated features. Therefore, the features defined as “first” or “second” may explicitly or implicitly include at least one feature. In addition, the various embodiments can be combined with one another. When the combined embodiments are contradictory or cannot be realized, it should be considered that such combined embodiments do not exist, and are not within the protection scope sought for by the disclosure.

With the improvement of living standards, electrical apparatuses such as refrigerators, dishwashers and disinfection cabinets have become widely used in lives of people. In particular, in order to maintain a sealing performance of the refrigerator, an adsorption structure is usually disposed between a main body and a door body thereof or negative pressure is maintained within the main body, to stably fix the door body to the main body. Although a related performance of the refrigerator is improved, a difficulty of opening the door body is also increased to a certain extent. A larger force is usually required to open the door body, and thus it is inconvenient to use. In the related art, in order to overcome a problem of difficulty in opening and closing a door body, a door opening and closing device is used to open or close the door body. However, a traditional door opening and closing device cannot be applied to double-door refrigerators. The traditional door opening and closing device, when used in cross-door refrigerators and other multi-door refrigerators, also needs additional protection during transportation and circulation. The door body of the refrigerators is prone to be displaced up and down during transportation and circulation. The double-door refrigerator has a special door self-locking structure, and thus the door body will inevitably move up and down in the process of opening and closing the door body. That is to say, the door body, when being opened and closed, will be displaced up and down, to cause a situation that the door opening and closing device gets stuck in movement or gets damage to components of the door opening and closing device due to an up and down displacement of the door body. The door opening and closing device according to some embodiments of the disclosure can ameliorate the above problems. The refrigerator provided according to some embodiments of the disclosure can minimize an impact of the up and down displacement of the door body on the door opening and closing device. A service life of the door opening and closing device can be increased. An adaptability, reliability, and usage experience of the door body can be improved.

Some embodiments of the disclosure are described below with reference to the accompanying drawings and embodiments.

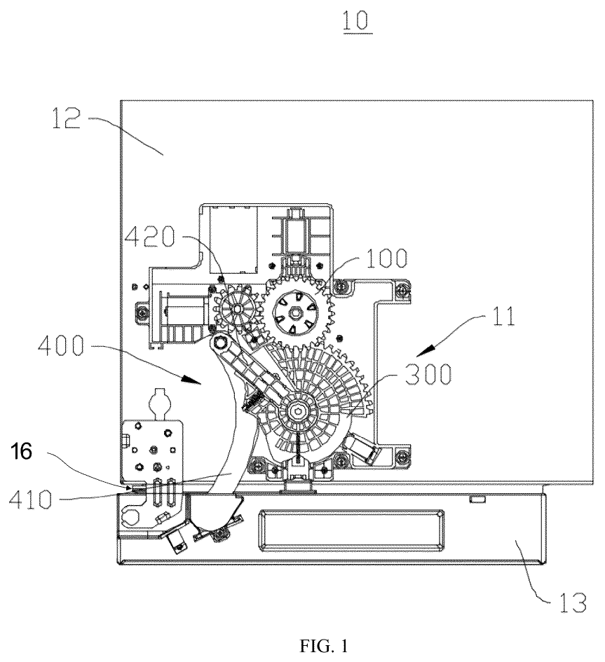

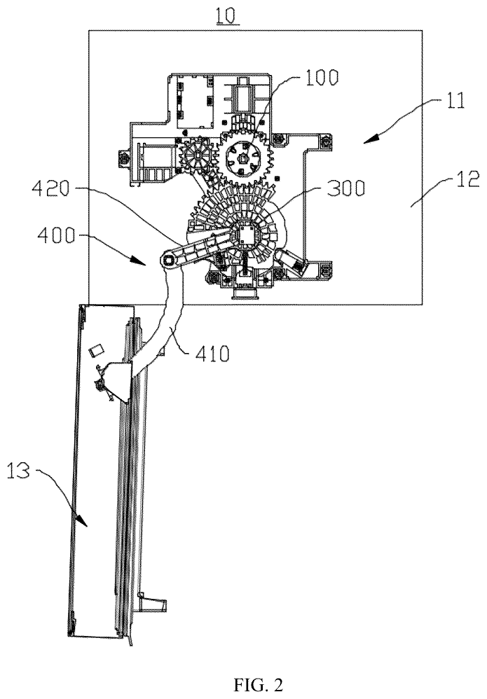

FIG. 1 shows a schematic structural diagram of a refrigerator with an opened door body according to some embodiments of the disclosure; and FIG. 2 shows a schematic structural diagram of the refrigerator with a closed door body according to some embodiments of the disclosure. As shown in FIG. 1 and FIG. 2, a refrigerator 10 is provided according to some embodiments of the disclosure. The refrigerator 10 can minimize an impact of a displacement of the door body 13 on a door opening and closing device 11, to increase a service life of the door opening and closing device 11.

In some embodiments of the disclosure, the refrigerator 10 may include: a main body 12, a door body 13 and a door opening and closing device 11. The main body 12 is formed with an accommodation space that has an opening. The door body 13 is rotatably disposed on the main body 12 through a rotating shaft 16 to enclose or open the opening. The door opening and closing device 11 is disposed on the main body 12 and connected to the door body 13. When the door opening and closing device 11 is activated, the door opening and closing device 11 drives the door body 13 to rotate relative to the main body 12 to open or close the door body 13. The door opening and closing device 11 includes a front connecting rod 410.

The door opening and closing device 11 may further include a driving mechanism 100, a transmission mechanism 300 and a door rotation mechanism 400. The driving mechanism 100 and the transmission mechanism 300 are both mounted on the main body 12. The door rotation mechanism 400 may include a front connecting rod 410 and a rear connecting rod 420. An end of the rear connecting rod 420 is connected to the transmission mechanism 300, and another end of the rear connecting rod 420 is connected to an end of the front connecting rod 410. An end of the front connecting rod 410 away from the rear connecting rod 420 is connected to a sliding member 510.

In some embodiments of the disclosure, the transmission mechanism 300 may be a linkage gear. The linkage gear is in transmission connection with the driving mechanism 100. The door rotation mechanism 400 is connected to the linkage gear. The driving mechanism 100 drives, through the linkage gear, the door rotation mechanism 400 to rotate to realize a function of door opening and closing. In some embodiments, the linkage gear can also be connected to a door ejection member and a suspension mechanism. Functions of door ejection, door rotation and suspension can be realized through one linkage gear, to be capable of reducing the number of components of the door opening and closing device 11 and improving an integration of the entire door opening and closing device 11.

It is easily understood that the transmission mechanism 300, in addition to being a linkage gear, can also be an ordinary transmission gear in some embodiments. The function of door opening and closing can also be realized in the way that the transmission gear drives the door rotation mechanism 400 to rotate.

In some embodiments, the transmission mechanism 300 may also be chain-driven or belt-driven to drive the door rotation mechanism 400 to rotate, to realize the function of door opening and closing through the door rotation mechanism 400.

It should be noted that several implementation ways of the transmission mechanism 300 are listed in some embodiments of the disclosure, but the implementation ways of the transmission mechanism 300 are not limited thereto. The transmission mechanisms 300 that can be connected to the driving mechanism 100 and can drive the door rotation mechanism 400 to rotate are all within a scope sought by the disclosure.

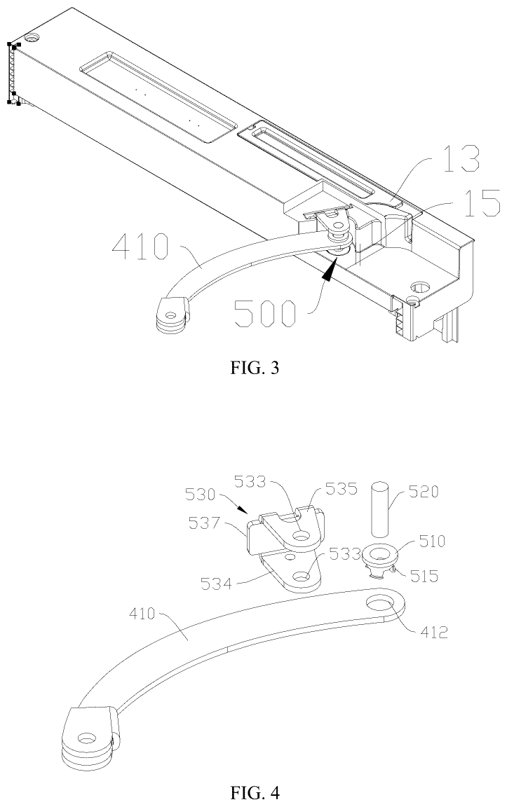

FIG. 3 is a schematic structural diagram showing a connection way between a front connecting rod and a door body of the refrigerator according to some embodiments of the disclosure; and FIG. 4 shows an exploded view of the front connecting rod and the door body of the refrigerator of FIG. 3. As shown in FIG. 3 and FIG. 4, in some embodiments, the refrigerator 10 may also include a sliding assembly 500 which includes a connecting member 520 and a sliding member 510. The connecting member 520 is fixed to one of the front connecting rod 410 and the door body 13. The sliding member 510 is disposed on another of the front connecting rod 410 and the door body 13. The sliding member 510 is movably connected to the connecting member 520, to enable the front connecting rod 410 to move relative to the door body 13 along an axial direction of the rotating shaft 16.

After the driving mechanism 100 receives a door opening signal, the driving mechanism 100 is activated to rotate forward, to drive the transmission mechanism 300 to rotate. The transmission mechanism 300 drives the door rotation mechanism 400 to rotate, to open the door body 13. After the driving mechanism 100 receives a door closing signal, the driving mechanism 100 is activated to rotate reversely, to drive the transmission mechanism 300 to rotate in an opposite direction, and thus the transmission mechanism 300 drives the door rotation mechanism 400 to rotate in the opposite direction to close the door body 13.

In some embodiments of the disclosure, one of the connecting member 520 and the sliding member 510 is connected to the front connecting rod 410, and another of the connecting member 520 and the sliding member 510 is connected to the door body 13 The sliding member 510 and the connecting member 520 are movably connected. When the door body 13 is displaced up and down, the door body 13 can slide up and down relative to the sliding member 510, to be capable of reducing a noise generated by a displacement of the refrigerator 10 during transportation, and avoiding a risk of the door opening and closing device 11 being stuck in movement and unable to open and close the door body normally. Thus, a normal operation of the door opening and closing device 11 can be ensured, and a damage to components of the door opening and closing device 11 can also be reduced, to increase a service life of the entire door opening and closing device 11.

The front connecting rod 410 may not be moved up and down with the door body 13, to be capable of reducing a risk of deformation of the front connecting rod 410 caused by an up and down displacement of the door body 13. Thus, a service life of the front connecting rod 410 can be improved, to improve the service life of the entire door opening and closing device 11.

In some embodiments, a fixing member 530 is disposed on the door body 13. The connecting member 520 is connected to the fixing member 530. The sliding member 510 is connected to the front connecting rod 410 and is slidably sleeved on the connecting member 520, to enable the front connecting rod 410 to move along an axial direction of the rotating shaft 16 relative to the connecting member 520.

In some embodiments of the disclosure, the sliding member 510 is slidably sleeved on the connecting member 520. The connecting member 520 is connected to the fixing member 530. In a condition that the door body 13 is displaced up and down, the sliding member 510 can slide relative to the connecting member 520, that is, when the door body 13 is displaced up and down, the door body 13 can slide up and down relative to the sliding member 510, while the front connecting rod 410 may not be displaced up and down with the door body 13, to be capable of reducing a noise generated by a displacement of the refrigerator 10 during transportation, and avoiding a risk of the door opening and closing device 11 being stuck in movement and unable to open and close the door body normally. Thus, a normal operation of the door opening and closing device 11 can be ensured. It can also reduce a risk of deformation of the front connecting rod 410 caused by an up and down displacement of the door body 13, and thus a service life of the front connecting rod 410 can be increased, to increase a service life of the entire door opening and closing device 11.

It should be noted that the up and down displacement of the door body 13 refers to a movement along an extension direction of the rotation shaft 16.

In some embodiments of the disclosure, the fixing member 530 is fixedly disposed on the door body 13, and the connecting member 520 is fixedly connected to the fixing member 530, that is, the door body 13, the fixing member 530 and the connecting member 520 are connected as a whole. When the door body 13 is displaced up and down, the fixing member 530 and the connecting member 520 will be driven to be displaced up and down with the door body 13. The sliding member 510 can slide relative to the connecting member 520, and thus the up and down displacement of the door body 13 will not be transmitted to the front connecting rod 410 and will not affect a normal operation of the door opening and closing device 11, to improve the service life of the entire door opening and closing device 11.

In other words, in a condition that the door body 13 is displaced up and down, the fixing member 530 and the connecting member 520 are displaced up and down along with the door body 13, to cause the connecting member 520 to slide relative to the sliding member 510. Among the connecting member 520 and the sliding member 510, the sliding member 510 is stationary and the connecting member 520 moves, to realize a sliding of the connecting member 520 relative to the sliding member 510.

In some embodiments, an extension direction of the connecting member 520 is the same as an extension direction of the rotating shaft 16. In a condition that the door body 13 is displaced, the sliding member 510 and the connecting member 520 slide relative to each other, and the sliding member 510 slides directly in the extension direction of the rotating shaft 16. Thus, a movement of the sliding member 510 in a direction at an angle to the extension direction of the rotating shaft 16 can be reduced; an interference between the connecting member 520 and the sliding member 510 during sliding can be reduced; and a shaking of the front connecting rod 410 can be minimized as much as possible. The shaking of the front connecting rod 410 affects an effect of door opening and closing of the door opening and closing device 11.

In some embodiments, a limiting hole 412 may be formed on the front connecting rod 410. The sliding member 510 is disposed in the limiting hole 412.

In some embodiments, the front connecting rod 410 may be sleeved outside the sliding member 510. That is, the sliding member 510 is sleeved on the connecting member 520. The front connecting rod 410 is sleeved on the sliding member 510. An order from inside to outside is: the connecting member 520, the sliding member 510, and the front connecting rod 410. The sliding member 510 is disposed in the limiting hole 412, to facilitate an assembly between the sliding member 510 and the front connecting rod 410.

That is to say, the sliding member 510 is sleeved on the connecting member 520. The front connecting rod 410 is sleeved on the sliding member 510. The sliding member 510 can slide relative to the connecting member 520 or rotate relative to the connecting member 520. The front connecting rod 410 is fixedly connected to the sliding member 510. The front connecting rod 410, via the sliding member 510, can slide and rotate relative to the connecting member 520, to slide and rotate relative to the door body 13. When the door body 13 is displaced up and down, the door body 13 can slide relative to the front connecting rod 410, while the front connecting rod 410 can remain stationary, and in turn to be capable of reducing a noise generated by a displacement of the refrigerator 10 during transportation, and avoiding a risk of the door opening and closing device 11 being stuck in movement and unable to open and close the door body normally. Thus, a normal operation of the door opening and closing device 11 can be ensured. A deformation of the front connecting rod 410 caused by the displacement of the door body 13 can be also reduced, and thus a damage to the front connecting rod 410 can be reduced, to increase a service life of the front connecting rod 410.

In some embodiments, a fixing slot 515 may be disposed on an outer peripheral surface of the sliding member 510. The limiting hole 412 is engaged into the fixing slot 515.

When the sliding member 510 and the front connecting rod 410 are assembled, the limiting hole 412 is engaged into the fixing slot 515, to be capable of reducing a risk of the front connecting rod 410 separating from the sliding member 510 and improving a fixing effect between the sliding member 510 and the front connecting rod 410.

In some embodiments, the limiting hole 412 is engaged into the fixing slot 515. Since a thickness of the front connecting rod 410 may be smaller than a length of the fixing slot 515, the front connecting rod 410 may move in a small range. In order to improve a fixing effect of the front connecting rod 410, a circlip is engaged into the fixing slot 515, to enable the front connecting rod 410 to be fixed in the fixing slot 515, and thus a mutual sliding between the front connecting rod 410 and the sliding member 510 can be avoided, to improve a fixing effect between the front connecting rod 410 and the sliding member 510.

It is easily understood that, in addition to this, a limiting portion can be protruded on the sliding member 510, and an engaging hole can be disposed in the limiting hole 412. The limiting portion can be engaged into the engaging hole, to also be capable of achieving a fixed connection between the sliding member 510 and the front connecting rod 410.

The fixing member 530 includes a first limiting portion 534 and a second limiting portion 535 that are oppositely disposed. An end of the connecting member 520 is connected to the first limiting portion 534, and another end of the connecting member 520 is connected to the second limiting portion 535.

In some embodiments, the connecting member 520 may be in a shape of an elongated strip, with an end connected to the first limiting portion 534 and another end connected to the second limiting portion 535, and thus the sliding member 510 can slide between the first limiting portion 534 and the second limiting portion 535, to prevent the sliding member 510 from sliding out of the connecting member 520 and reduce a risk of separating of the sliding member 510 and the connecting member 520.

In some embodiments, the first limiting portion 534 and the second limiting portion 535 are both provided with connecting holes 533. Two ends of the connecting member 520 are respectively installed in two connecting holes 533.

The door body 13 has an installation groove 15. The first limiting portion 534 is connected to a bottom wall of the installation groove 15. The second limiting portion 535 is disposed at an opening of the installation groove 15. Two ends of the connecting member 520 are respectively installed in the two connecting holes 533 and fixedly connected to the connecting holes 533. The connecting member 520 can be fixed by a simple structure, which has a simple and convenient operation.

In some embodiments, the two connection holes 533 are coaxially disposed.

The two connecting holes 533 are coaxially disposed and thus the connecting member 520 can be disposed in a vertical direction, that is, in a direction which is the same as the extension direction of the rotating shaft 16. In a condition that the door body 13 is displaced, the front connecting rod 410 can move relative to the door body 13, and thus the front connecting rod 410 does not move with the door body 13, to be capable of reducing a noise generated by a displacement of the refrigerator 10 during transportation, and avoiding a risk of the door opening and closing device 11 being stuck in movement and unable to open and close the door body normally. Thus, a normal operation of the door opening and closing device 11 can be ensured.

In some embodiments, the fixing member 530 may further include a transition portion 537. The first limiting portion 534 and the second limiting portion 535 are connected to the transition portion 537. The first limiting portion 534 is connected to the door body 13.

An end of the transition portion 537 is connected to the first limiting portion 534, and another end of the transition portion 537 is connected to the second connecting portion 532. The first limiting portion 534 is fixedly connected to the door body 13, to fix the entire fixing member 530 on the door body 13.

It is easily understood that the fixing member 530 may not include the transition portion 537, and the first limiting portion 534 and the second limiting portion 535 are directly connected to the door body 13. The first limiting portion 534 and the second limiting portion 535 are connected through the transition portion 537 and then connected to the door body 13, to be capable of reducing the number of connections between the fixing member 530 and the door body 13, and thus a damage to the door body 13 can be reduced.

In some embodiments, the fixing member 530 is disposed in the installation groove 15. The first limiting portion 534 is fixedly connected to a bottom wall of the installation groove 15. The first limiting portion 534 may be attached to the bottom wall of the installation groove 15 and is fixedly connected to the bottom wall of the installation groove 15 by screws. The first limiting portion 534 being fixedly disposed on the bottom wall of the installation groove 15 can make an appearance of entire structure integrated and improve aesthetics of an electrical apparatus.

In some embodiments, the first limiting portion 534 is fixedly connected to the bottom wall of the installation groove 15. It is suitable for a structure in which a thickness of the door body 13 is relatively large. The door body 13 can be prevented from being pierced by screws to be damaged.

It can be seen that the above is only one implementation way of the fixing member 530 and the connecting member 520. In addition, the fixing member 530 and the connecting member 520 may have other implementation ways and ways for fixing to the door body 13.

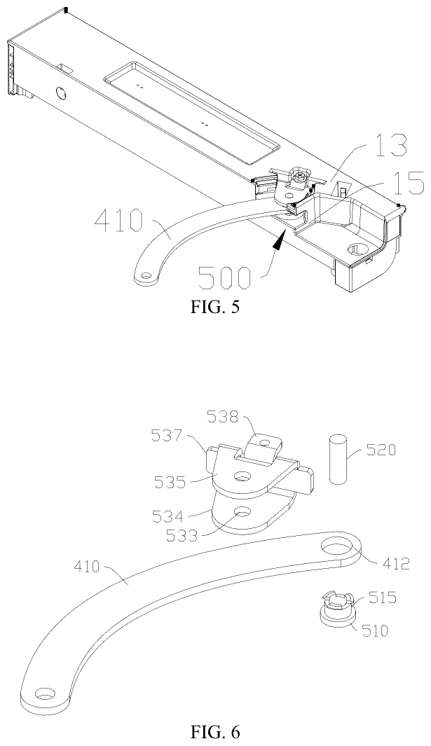

FIG. 5 is a schematic structural diagram showing a connection way between a front connecting rod and a door body of the refrigerator according to some embodiments of the disclosure; and FIG. 6 shows an exploded view of the front connecting rod and the door body of the refrigerator of FIG. 5. As shown in FIG. 5 and FIG. 6, in some other embodiments, the fixing member 530 may further include an installation portion 538. The transition portion 537 connects the first limiting portion 534 and the second limiting portion 535. The installation portion 538 is connected to the transition portion 537 and is connected to the door body 13.

The installation portion 538 is connected to the door body 13, to be capable of reducing connection positions between the entire fixing member 530 and the door body 13, and thus the first limiting portion 534 and the second limiting portion 535 only play a role of limiting.

In some other embodiments, the transition portion 537, the first limiting portion 534, and the second limiting portion 535 are disposed in the installation groove 15.

In some embodiments, the installation portion 538 is disposed outside the installation groove 15. The first limiting portion 534 contacts the bottom wall of the installation groove 15. The transition portion 537 contacts a side wall of the installation groove 15. The installation portion 538 is connected to an end of the transition portion 537 that is connected to the second limiting portion 535, and has an extension direction that is opposite to that of the second limiting portion 535, to enable the installation portion 538 to extend from the opening of the installation groove 15 to an outside of the installation groove 15 and be fixedly connected to the door body 13.

In some embodiments, the installation portion 538 is fixedly connected to the door body 13 by screws. It is suitable for a structure in which a thickness of the door body 13 is relatively small. The door body 13 can be prevented from being pierced by screws to be damaged.

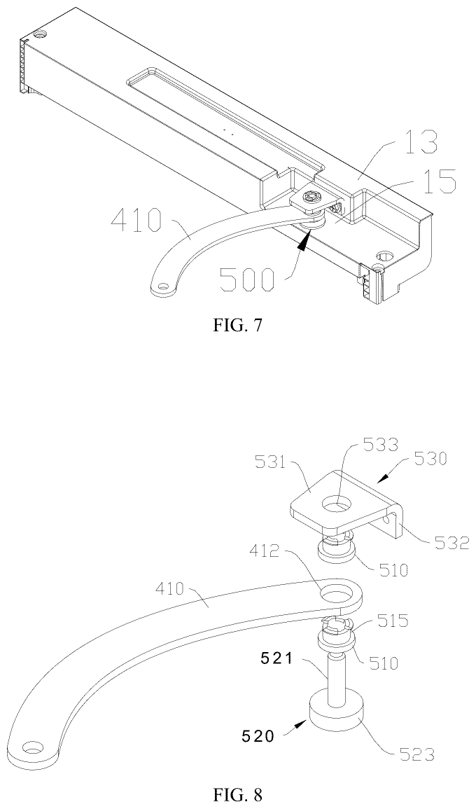

FIG. 7 is a schematic structural diagram showing a connection way between a front connecting rod and a door body of the refrigerator according to some embodiments of the disclosure; and FIG. 8 shows an exploded view of the front connecting rod and the door body of the refrigerator of FIG. 7. FIG. 7 and FIG. 8 show another implementation way of the fixing member 530 and the connecting member 520. As shown in FIG. 7 and FIG. 8, in some embodiments, the fixing member 530 includes a fixing portion 531 and a connecting portion 532 that are connected to each other. The connecting portion 532 is connected to the door body 13. The connecting member 520 includes a connecting shaft 521 and an end cover 523. The end cover 523 is disposed at an end of the connecting shaft 521. An end of the connecting shaft 521 away from the end cover 523 is connected to the fixing portion 531. The sliding member 510 is sleeved on the connecting shaft 521, and the front connecting rod 410 can slide between the fixing portion 531 and the end cover 523.

The fixing portion 531 and the connecting portion 532 are connected to each other. An end of the connecting shaft 521 is connected to the fixing portion 531, and another end of the connecting shaft 521 is connected to the end cover 523. Thus, the sliding member 510 can slide between the fixing portion 531 and the end cover 523. The fixing portion 531 and the end cover 523 play a role of limiting to prevent the sliding member 510 from falling off the connecting shaft 521.

An extension direction of the connecting shaft 521 is the same as the extension direction of the rotating shaft 16. When the door body 13 is displaced up and down, the sliding member 510 can drive the front connecting rod 410 to directly slide relative to the door body 13 along the extension direction of the rotating shaft 16, to avoid the front connecting rod 410 from being unable to open or close the door body 13 normally due to a deformation of the front connecting rod 410 caused by the displacement of the door body 13.

In some embodiments, the connecting shaft 521 and the end cover 523 are integrally formed. The entire connecting member 520 is substantially T-shaped, and the fixing portion 531 is disposed at another end of the connecting shaft 521, and thus the connecting member 520 and the fixing portion 531 are substantially I-shaped.

In some embodiments, a connecting hole 533 is disposed on the fixing portion 531. An end of the connecting shaft 521 away from the end cover 523 is installed in the connecting hole 533. Similarly, in order to facilitate a cooperation between the connecting shaft 521 and the connecting hole 533, a sliding member 510 is disposed between the connecting hole 533 and the connecting shaft 521. The connecting hole 533 is engaged into a fixing slot 515 of the sliding member 510. The sliding member 510 is sleeved on an end of the connecting shaft 521 away from the end cover 523. If the connecting shaft 521 moves relative to the fixing portion 531 along the extension direction of the rotating shaft 16, the connecting shaft 521 can move relative to the connecting hole 533, to prevent the front connecting rod 410 from moving and reduce a deformation of the front connecting rod 410.

In some embodiments, the fixing member 530 and the connecting member 520 are disposed in the installation groove 15. The end cover 523 contacts the bottom wall of the installation groove 15. The connecting portion 532 is fixedly connected to the side wall of the installation groove 15.

The end cover 523 is installed on the bottom wall of the installation groove 15, to be capable of avoiding the connecting shaft 521 from falling out of the connecting hole 533. The connecting portion 532 is fixedly connected to the side wall of the installation groove 15, that is, the connecting member 520 and fixing member 530 are both disposed in the installation groove 15. The connecting portion 532 is connected to the door body 13 in a thickness direction of the door body 13.

In some embodiments, the fixing portion 531 and the connecting portion 532 are connected at an angle.

The end cover 523 is disposed on the bottom wall of the installation groove 15. The end cover 523 and the fixing portion 531 are respectively disposed at two ends of the connecting shaft 521, that is, the end cover 523 and the fixing portion 531 are oppositely disposed. The fixing portion 531 is disposed close to the opening of the installation groove 15. The connecting portion 532 is connected to the side wall of the installation groove 15. In order to reduce connections between the fixing portion 531 to the connecting shaft 521, the connecting portion 532 is connected to the side wall of the installation groove 15, and thus the fixing portion 531 and the connecting portion 532 are required to be disposed at an angle.

In some embodiments, the fixing portion 531 and the connecting portion 532 are perpendicular to each other, and thus the connecting portion 532 can be attached to the side wall of the installation groove 15, to improve a fixing effect between the connecting portion 532 and the installation groove 15 and reduce a deformation of the connecting portion 532.

The connecting portion 532 and the side wall of the installation groove 15 are connected by screws. A connection by screw is convenient and simple and easy to operate.

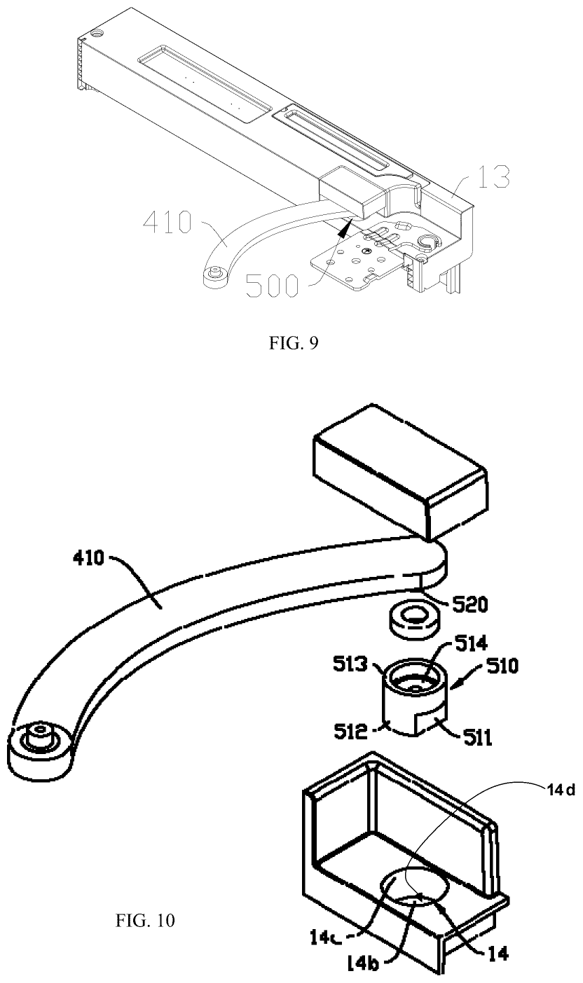

FIG. 9 is a schematic structural diagram showing a connection way between a front connecting rod and a door body of the refrigerator according to some embodiments of the disclosure; and FIG. 10 shows an exploded view of the front connecting rod and the door body of the refrigerator of FIG. 9. As shown in FIG. 9 and FIG. 10, in some embodiments, the sliding member 510 has an installation hole 514. The connecting member 520 is disposed on the front connecting rod 410. The connecting member 520 is installed in the installation hole 514.

The connecting member 520 is disposed on the front connecting rod 410. The connecting member 520 is disposed in the installation hole 514. The connecting member 520 can be rotated relative to the installation hole 514. In a condition that the door opening and closing device 11 is activated, the transmission mechanism 300 drives the door rotation mechanism 400 to rotate, and the front connecting rod 410, through the connecting member 520, drives the door body 13 to rotate, to open the door body 13.

In some embodiments, the connecting member 520, the installation hole 514, and the fixing hole 14 are coaxially disposed. The fixing hole 14, the connecting member 520 and the installation hole 514 are coaxially disposed. Thus, a door-opening stability can be improved when the front connecting rod 410 drives the door body 13 to rotate.

In some embodiments, a shape of the sliding member 510 matches a shape of the fixing hole 14. The shape of the sliding member 510 matching the shape of the fixing hole 14 enables the sliding member 510 to move in an extension direction of the fixing hole 14, to reduce an influence of the up and down displacement of the door body 13 on the front connecting rod 410.

In some embodiments, a length of the fixing hole 14 is greater than a length of the sliding member 510. During a displacement of the door body 13, a larger depth of the fixing hole 14 can provide a larger sliding space for the sliding member 510, to be capable of avoiding as much as possible a situation in which a bottom of the sliding member 510 abuts against a bottom wall of the fixing hole 14 due to excessive up and down displacement of the door body 13, causing the front connecting rod 410 to move accordingly.

In some embodiments, a fixing hole 14 is disposed on the door body 13. The sliding member 510 is sleeved on the front connecting rod 410 and installed in the fixing hole 14. In a condition that the door opening and closing device 11 opens or closes the door body 13, if the door body 13 is displaced up and down, the sliding member 510 can move relative to the fixing hole 14 along an axial direction of the rotating shaft 16, that is, when the door body 13 is displaced up and down, the door body 13 can slide up and down relative to the sliding member 510, and the front connecting rod 410 will not be displaced up and down with the door body 13. Thus, an adaptability, reliability and usage experience of the door body 13 can be improved. At the same time, an impact of the up and down displacement of the door body 13 on the door opening and closing device 11 can be reduced. A situation in which the door opening and closing device 11 gets stuck in movement due to the up and down displacement of the door body 13 can be reduced. A damage to components of the door opening and closing device 11 can be reduced. A service life of the entire door opening and closing device 11 can be increased.

Of cause, as the front connecting rod 410 is directly connected to the door body 13, a risk of deformation of the front connecting rod 410 caused by the up and down displacement of the door body 13 can also be reduced. Thus, a service life of the front connecting rod 410 can be improved, to be capable of improving the service life of the entire door opening and closing device 11.

When the door body 13 is opened or closed, if the door body 13 is displaced up and down, the sliding member 510 can move along an axial direction of the rotating shaft 16 relative to the fixing hole 14, while the front connecting rod 410 can remain stationary. Thus, the up and down displacement of the door body 13 will not be transmitted to the front connecting rod 410. An impact of the up and down displacement of the door body 13 on the door opening and closing device 11 can be reduced. A situation in which the door opening and closing device 11 gets stuck in movement due to the up and down displacement of the door body 13 can be reduced. A damage to components of the door opening and closing device 11 can be reduced. A service life of the entire door opening and closing device 11 can be increased.

It should be noted that the up and down displacement of the door body 13 refers to a movement along an extension direction of the rotation shaft 16.

In some embodiments, the fixing hole 14 is disposed above the door body 13, that is, disposed on an upper surface of the door body 13. The front connecting rod 410 is connected to the sliding member 510. The sliding member 510 is disposed in the fixing hole 14. Thus, the front connecting rod 410 is disposed above the door body 13, and from above the door body 13 drives the door body 13 to rotate.

In some embodiments, the fixing hole 14 has a fixing surface 14d. A stop surface 511 is provided on the sliding member 510. The fixing surface 14d cooperates with the stop surface 511. In some embodiments, a shape of the fixing surface 14d is different from a shape of the fixing hole 14, and a shape of the stop surface 511 is different from a shape of the sliding member 510.

The shape of the fixing surface 14d being different from the shape of the fixing hole 14 indicates that the shape of the fixing surface 14d is different from a shape of a hole wall of the fixing hole 14. Similarly, the shape of the stop surface 511 being different from the shape of the sliding member 510 indicates that the shape of the stop surface 511 is different from a contour of the sliding member 510.

The shape of the fixing surface 14d is different from that of the fixing hole 14, and the shape of the stop surface 511 is different from that of the sliding member 510. After the sliding member 510 is installed in the fixing hole 14, the sliding member 510 cannot be rotated relative to the fixing hole 14, to avoid a situation in which the sliding member 510 is rotated relative to the door body 13 when the front connecting rod 410 drives the door body 13 to rotate. This situation results in that the front connecting rod 410 is unable to drive the door body 13 to be opened or closed.

In some embodiments, the shape of the stop surface 511 matches the shape of the fixing surface 14d, which indicates that the shapes of the stop surface 511 and the fixing surface 14d are the same. In an embodiment, if the fixing surface 14d is a plane, the stop surface 511 is also a plane. If the fixing surface 14d is a curved surface, the stop surface 511 is also a curved surface, as long as the two can be matched.

It should be noted that the fixing surface 14d is disposed on the fixing hole 14. The shape of the fixing surface 14d being different from the shape of the fixing hole 14 indicates that the shape of the fixing surface 14d is different from shapes of other portions of the fixing hole 14. Similarly, the stop surface 511 is disposed on the sliding member 510. The shape of the stop surface 511 being different from the shape of the sliding member 510 indicates that the shape of the stop surface 511 is different from shapes of other portions of the sliding member 510.

In some embodiments, the sliding member 510 is cylindrical. The stop surface 511 is disposed on a peripheral wall of the sliding member 510, that is, the sliding member 510 is an incomplete cylinder, and is a cylinder with a notch. Similarly, the fixing hole 14 is circular, the stop surface 511 is disposed on the hole wall of the fixing hole 14, and the fixing hole 14 is circular with a notch.

In some embodiments, the fixing hole 14 includes a fixing section 14b and a connecting section 14c that are interconnected. The sliding member 510 includes a stop section and an installation section 513 that are interconnected. The installation section is disposed close to the front connecting rod 410. The fixing section 14b cooperates with the stop section. The connecting section 14c cooperates with the installation section. The fixing surface 14d is disposed on the fixing section 14b. The stop surface 511 is disposed on the stop section.

In some embodiments, the installation section is disposed close to the front connecting rod 410. The fixing section 14b is disposed close to a bottom of the fixing hole 14, and the stop surface 511 is disposed a lower portion of the sliding member 510, to facilitate an installation of the sliding member 510 and reduce a difficulty in installing the sliding member 510 to the fixing hole 14.

In some embodiments, the fixing section 14b is disposed below the connecting section 14c. In order to make the connecting section 14c to cooperate with the installation section, and make the fixing section 14b to cooperate with the stop section, it is required to dispose the fixing section 14b below the connecting section 14c.

In some embodiments, the fixing hole 14 is circular. A diameter of the fixing section 14b is smaller than a diameter of the connecting section 14c. The sliding member 510 is cylindrical. A diameter of the stop section is smaller than a diameter of the installation section.

The diameter of the fixing section 14b is smaller than the diameter of the connecting section 14c. The diameter of the stop section is smaller than the diameter of the installation section. Since the fixing surface 14d is disposed on the fixing section 14b, the fixing section 14b is not a complete cylinder. The fixing section 14b and the connecting section 14c are coaxially disposed. A diameter of the fixing section 14b refers to twice a radius of an arc portion of the fixing section 14b.

Similarly, the stop surface 511 is disposed on the stop section, and thus the stop section is also not a complete cylinder. The stop section and the installation section are coaxially disposed. A diameter of the stop section refers to twice a radius of an arc portion of the stop section.

To sum up, one of the connecting member 520 and the sliding member 510 is connected to the front connecting rod 410, and another of the connecting member 520 and the sliding member 510 is connected to the door body 13. The sliding member 510 and the connecting member 520 are slidably connected. When the door body 13 is displaced up and down, the door body 13 can slide up and down relative to the sliding member 510, while the front connecting rod 410 will not be displaced up and down with the door body 13. Thus, a risk of deformation of the front connecting rod 410 due to the up and down displacement of the door body 13 can be reduced. A situation in which the door opening and closing device 11 gets stuck in movement due to the up and down displacement of the door body 13 can be reduced to a certain extent. A damage to components of the door opening and closing device 11 due to the up and down displacement of the door body 13 can be reduced to a certain extent. Thus, a service life of the front connecting rod 410 can be increased, to increase a service life of the entire door opening and closing device 11.

In the description of this specification, the description with reference to the terms “one embodiment”, “some embodiments”, “example”, “specific example”, or “some examples” and so on means that the specific features, structures, materials or characteristics described in conjunction with the embodiment or example are included in at least one embodiment or example of the disclosure. In the specification, the exemplary expressions of the above terms do not necessarily refer to the same embodiment or example. Furthermore, the specific features, structures, materials, or characteristics described may be combined in any suitable manner in any one or more embodiments or examples.

1. A refrigerator, comprising:
a main body formed with an accommodation space that has an opening;
a door body rotatably disposed on the main body via a rotating shaft to enclose or open the opening;
a door opening and closing device disposed on the main body and connected to the door body, wherein when the door opening and closing device is activated, the door opening and closing device drives the door body to rotate relative to the main body to open or close the door body, the door opening and closing device comprising a front connecting rod; and
a sliding assembly comprising a connecting member and a sliding member, wherein the connecting member is fixed to one of the front connecting rod and the door body, the sliding member being disposed on another of the front connecting rod and the door body, the sliding member being movably connected to the connecting member, to enable the front connecting rod to move along an axial direction of the rotating shaft relative to the door body.

2. The refrigerator according to claim 1, wherein a fixing hole is disposed on the door body, the connecting member being disposed on the front connecting rod, the sliding member being sleeved on the connecting member and installed in the fixing hole, and wherein in a condition that the door opening and closing device opens or closes the door body, the sliding member is able to move along the axial direction of the rotating shaft in the fixing hole.

3. The refrigerator according to claim 1, wherein a fixing hole has a fixing surface, a stop surface being provided on the sliding member, the fixing surface cooperating with the stop surface, wherein a shape of the fixing surface is different from a shape of the fixing hole, a shape of the stop surface being different from a shape of the sliding member.

4. The refrigerator according to claim 1, wherein a fixing hole comprises a fixing section and a connecting section that are interconnected, and wherein the sliding member comprises a stop section and an installation section that are interconnected, the installation section being disposed close to the front connecting rod, the fixing section cooperating with the stop section, the connecting section cooperating with the installation section, the fixing surface being disposed on the fixing section, a stop surface being disposed on the stop section.

5. The refrigerator according to claim 3, wherein the shape of the stop surface matches the shape of the fixing surface.

6. The refrigerator according to claim 1, wherein a fixing member is disposed on the door body, the connecting member being connected to the fixing member, the sliding member being fixedly connected to the front connecting rod and being sleeved on the connecting member, to enable the front connecting rod to move along the axial direction of the rotating shaft relative to the connecting member.

7. The refrigerator according to claim 1, wherein a limiting hole is formed on the front connecting rod, the sliding member being disposed in the limiting hole.

8. The refrigerator according to claim 7, wherein a fixing slot is disposed on an outer peripheral surface of the sliding member, the limiting hole is engaged into the fixing slot.

9. The refrigerator according to claim 6, wherein the fixing member comprises a fixing portion and a connecting portion that are interconnected, the connecting portion being connected to the door body, wherein the connecting member comprises a connecting shaft and an end cover, the end cover being disposed at an end of the connecting shaft, an end of the connecting shaft away from the end cover being connected to the fixing portion, the refrigerator being sleeved on the connecting shaft, to make the front connecting rod to be capable of sliding between the fixing portion and the end cover.

10. The refrigerator according to claim 9, wherein the door body has an installation groove, the fixing member and the connecting member being disposed in the installation groove, the end cover contacting a bottom wall of the installation groove, the connecting portion being fixedly connected to a side wall of the installation groove.

11. The refrigerator according to claim 6, wherein the fixing member comprises a first limiting portion and a second limiting portion that are oppositely disposed, an end of the connecting member being connected to the first limiting portion, another end of the connecting member being connected to the second limiting portion.

12. The refrigerator according to claim 11, wherein the fixing member further comprises a transition portion, the first limiting portion and the second limiting portion being connected through the transition portion, the first limiting portion being connected to the door body.

13. The refrigerator according to claim 11, wherein the door body has an installation groove, the fixing member being disposed in the installation groove, the first limiting portion being fixedly connected to a bottom wall of the installation groove.

14. The refrigerator according to claim 11, wherein the fixing member further comprises a transition portion and an installation portion, the transition portion connecting the first limiting portion and the second limiting portion, the installation portion being connected to the transition portion and to the door body.

15. The refrigerator according to claim 12, wherein the door body has an installation groove, and wherein the transition portion, the first limiting portion and the second limiting portion are disposed in the installation groove, an installation portion being disposed outside the installation groove.

16. The refrigerator according to claim 1, wherein the door opening and closing device further comprises a driving mechanism, a transmission mechanism and a door rotation mechanism, the driving mechanism and the transmission mechanism being both mounted on the main body, wherein the door rotation mechanism further comprises a rear connecting rod, an end of the rear connecting rod being connected to the transmission mechanism, another end of the rear connecting rod being connected to an end of the front connecting rod, an end of the front connecting rod away from the rear connecting rod being connected to the sliding member.
